(19) United States
(12) Patent Application Publication
(10) Pub. No.: US 2009/0160864 A1
(43) Pub. Date: Jun. 25, 2009

(54) IMAGE PROCESSOR AND IMAGE PROCESSING METHOD

(75) Inventor: Michio Yamashita, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/337,360

(22) Filed: Dec. 17, 2008

(30) Foreign Application Priority Data
Dec. 25, 2007 (JP) 2007-332934

(51) Int. Cl. G06F 15/00

(52) U.S. Cl. 345/501

(57) ABSTRACT

According to one embodiment, an image processor has a resolution detector, a first resolution changing unit, a second resolution changing unit, and a resolution changing controller. The resolution detector detects a resolution of an input image data. The first resolution changing unit changes the detected resolution into a resolution that is higher than the detected resolution. The second resolution changing unit changes the detected resolution coinciding with a predetermined input resolution into a predetermined output resolution that is higher than the detected resolution so as to provide the input image data with a definition higher than a definition of an output image data provided with the resolution changed by the first resolution changing unit. The resolution changing controller activates the first resolution changing unit to change the detected resolution that does not coincide with the predetermined input resolution into the predetermined input resolution, and activates subsequently the second resolution changing unit.

### CROSS-REFERENCE TO RELATED APPLICATIONS

This application is based upon and claims the benefit of priority from Japanese Patent Application No. 2007-332934, filed Dec. 25, 2007, the entire contents of which are incorporated herein by reference.

### BACKGROUND

1. Field

One embodiment of the invention relates to an image processor and an image processing method that performs an image expansion process and the like.

2. Description of the Related Art

Conventionally, an image processor that performs an process such as an expansion or a contraction of an image displayed on a display such as a liquid crystal display panel and the like is known. Such image processor is, for example, a personal computer, a TV, a data recorder that records data on a recording medium by a DVD, and the like.

Many image processors of the aforementioned type reproduce moving image data by software. Recently, software providing a function to generate image data with a resolution higher than an input moving image data has been making an appearance. Such software includes a multiple frame degradation inverse conversion method. The multiple frame degradation inverse conversion method is built by focusing on the fact that a subject projected on a reference frame is also projected on other frame. The multiple frame degradation inverse conversion method detects a movement of the subject with high accuracy within a pixel interval or less, determining a plurality of sample values of which positions are deviated very little from one another relative to a same local portion of the subject, and thereby increasing the resolution of the image data (for example, refer to Japanese Patent Application Publication (KOKAI) No. 2000-188680).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an external appearance of a computer according to an embodiment of the invention;

FIG. 2 is an exemplary block diagram of an internal configuration of the computer shown in FIG. 1 in the embodiment;

FIG. 3 is an exemplary block diagram of an internal configuration of a graphics controller in the embodiment;

FIG. 4 is an exemplary flowchart of a resolution changing process in the embodiment;

FIG. 5A is an exemplary view of a resolution table corresponding to a simple resolution changing unit in the embodiment;

FIG. 5B is an exemplary view of a resolution table corresponding to a high-quality resolution changing unit in the embodiment;

FIG. 5C is an exemplary view of a resolution table corresponding to a special resolution changing unit in the embodiment; and

FIG. 6 is an exemplary block diagram of an internal configuration of another graphics controller in the embodiment.

### DETAILED DESCRIPTION

Various embodiments according to the invention will be described hereinafter with reference to the accompanying drawings. In the following, the same reference numerals are used for the same elements, and the repeated explanations thereof are omitted. In general, according to one embodiment of the invention, an image processor has a resolution detector, a first resolution changing unit, a second resolution changing unit, and a resolution changing controller. The resolution detector detects a resolution of an input image data. The first resolution changing unit changes the detected resolution into a resolution that is higher than the detected resolution. The second resolution changing unit changes the detected resolution coinciding with a predetermined input resolution into a predetermined output resolution that is higher than the detected resolution so as to provide the input image data with a definition higher than a definition of an output image data provided with the resolution changed by the first resolution changing unit. The resolution changing controller activates the first resolution changing unit to change the detected resolution that does not coincide with the predetermined input resolution into the predetermined input resolution, and activates subsequently the second resolution changing unit.

According to another embodiment of the invention, an image processing method includes detecting a resolution of an input image data, changing the detected resolution not coinciding with a predetermined input resolution into the predetermined input resolution that is higher than the detected resolution, and changing the detected resolution that coincides with the predetermined input resolution into a predetermined output resolution that is higher than the detected resolution so as to provide the input image data with a definition higher than a definition of an output image data provided with the predetermined input resolution.

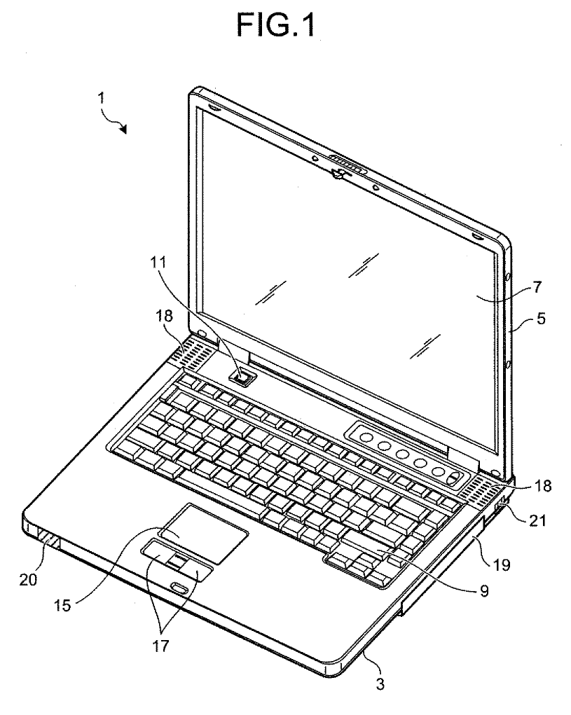

A personal computer (hereinafter, referred to as a “computer”) 1 of notebook-type shown in FIG. 1 includes a computer main body 3 and a display unit 5 that can be opened and closed relative to the computer main body 3.

A TFT-LCD (Thin Film Transistor Liquid Crystal Display) 7 is built in the display unit 5, and a display screen of the LCD 7 is located at approximately a center of the display unit 5.

The display unit 5 is attached rotatably between an opened position and a closed position relative to the computer main body 3. The computer main body 3 has a thin box-type casing. A keyboard 9, a power button 11 that is used to switch on and off the computer 1, a touch pad 15, a click button 17, and a speaker 18 are disposed on an upper surface of the computer main body 3.

The computer 1 can reproduce video data and audio data by using digital data stored in a DVD medium in an HD DVD standard (in an HD DVD Video standard). A slot 19 for taking in and out the DVD medium is provided at a right side surface of the computer main body 3.

A remote controller interface (remote controller I/F) 20 is provided at a front surface of the computer main body 3 to communicate with a remote controller that controls a TV function of the computer 1. The remote controller I/F 20 is configured by an infrared receiver and the like.

The computer 1 can receive a digital broadcast program, and can reproduce video and audio of the received program. Here, the digital broadcast is, for example, a terrestrial digital TV broadcast. An antenna terminal 21 for the terrestrial digital TV broadcast is provided at a right side surface of the computer main body 3.

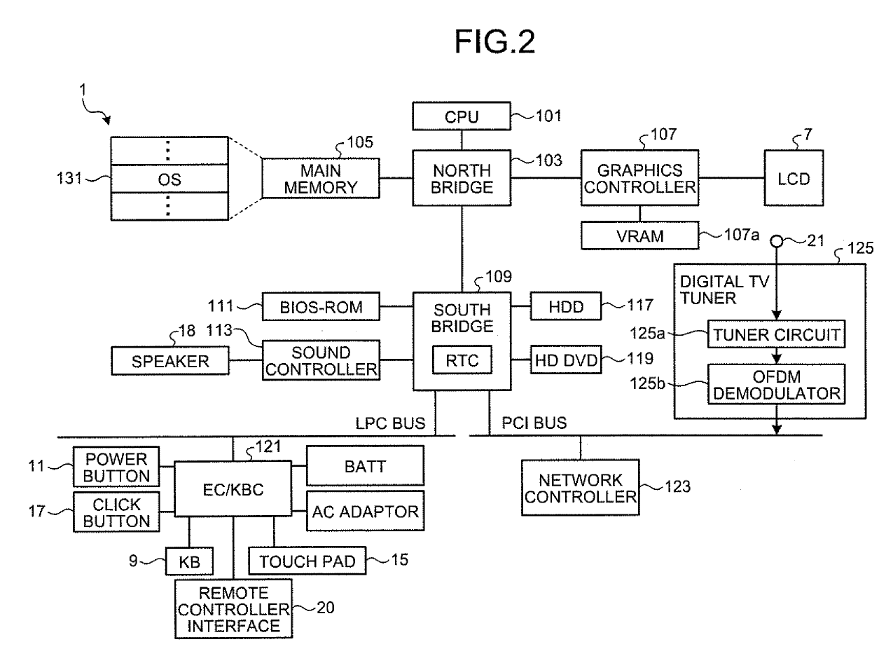

An internal configuration of the computer 1 is described with reference to FIG. 2 in the following. As shown in FIG. 2, the computer 1 includes a CPU 101, a north bridge 103, a main memory 105, a graphics controller 107, a video memory (VRAM) 107a, a south bridge 109, a BIOS-ROM 111, a sound controller 113, a hard disk drive (HDD) 117, an HD DVD drive 119, an embedded controller/keyboard controller IC (EC/KBC) 121, a network controller 123, a digital TV tuner 125, and the like.

The CPU 101 is a processor that controls operations of the computer 1, and executes various programs loaded from the HDD 117 into the main memory 105. The various programs executed by the CPU 101 includes an operating system 131, an HD DVD player application program that reproduces AV contents in HD DVD Video standard, a TV application that enables a viewing of a digital TV broadcast, and the like.

The CPU 101 also executes a BIOS (Basic Input Output System; a program to control hardware) stored in the BIOS-ROM 111.

The north bridge 103 is a bridge device that connects a local bus of the CPU 101 and the south bridge 109 with each other. The north bridge 103 houses a memory controller that controls access to the main memory 105. Further, the north bridge 103 communicates with the graphics controller 107 via a not-shown PCI EXPRESS bus and the like.

The graphics controller 107 is a display controller that controls the LCD 7 used as a display monitor of the computer 1. The graphics controller 107 has a blend processing function and an image processing function such as a resolution changing process described in the following. Accordingly, the graphics controller 107 functions as an image processor. A display signal that is video data generated by the graphics controller 107 is transmitted to the LCD 7. The display signal can also be transmitted to an external TV or HDMI monitor via an interface provided at the computer main body 3.

The south bridge 109 controls each device on a PCI (Peripheral Component Interconnect) bus and each device on a LPC (Low Pin Count) bus. Further, the south bridge 109 houses an IDE (Integrated Drive Electronics) controller that controls the HDD 117 and the HD DVD drive 119.

The south bridge 109 communicates with the sound controller 113. The sound controller 113 is a sound source device, and outputs reproduced data to the speaker 18.

The embedded controller/keyboard controller IC (EC/KBC) 121 is a one-chip microcomputer in which an embedded controller for power management and a keyboard controller are integrated. Here, the keyboard controller controls the keyboard 9, the touch pad 15, the click button 17, and the remote controller I/F 20.

An operation signal is generated when the touch pad 15 is operated, and accordingly, a cursor displayed on the display screen of the LCD 7 moves based on the operation signal. The EC/KBC 121 turns on and off the computer 1 in accordance with an operation of the power button 11 by a user.

The computer 1 includes the digital TV tuner 125 to enable the viewing of the digital TV broadcast. The CPU 101 executes the above-stated TV application, and as a result, TV video based on a digital broadcast wave received at the digital TV tuner 125 is displayed on the LCD 7.

The digital TV tuner 125 is a receiver that receives a digital broadcast program, and is connected to the antenna terminal 21. Here, the digital broadcast is, for example, the terrestrial digital TV broadcast. The digital TV tuner 125 has a tuner circuit 125a and an OFDM (Orthogonal Frequency Division Multiplexing) demodulator 125b.

The tuner circuit 125a receives a broadcast signal of a specific channel from among TV broadcast signals input from the antenna terminal 21. The OFDM demodulator 125b demodulates the broadcast signal of a specific channel received by the tuner circuit 125a, and retrieves a transport stream (TS) from the broadcast signal of the specific channel. The transport stream is a data stream in which compression-coded broadcast program data is multiplexed.

In the terrestrial digital TV broadcast, the transport stream corresponding to the broadcast program data of each channel has compression-coded moving image data, compression-coded audio data, and graphics data. The graphics data is also compression-coded. The graphics data includes subtitle data, still image, and characters/graphics data. The still image and the characters/graphics data are included in the broadcast program data of each channel as data broadcast. The data broadcast provides weather forecasts, news, and the like.

In the terrestrial digital TV broadcast, subtitle is referred to as caption data and the still images is referred to as picture. Further, the characters/graphics data is referred to as figure. Script information describing a procedure to present the graphics data is added to the graphics data. The script information is referred to as BML (Broadcast Markup Language) and written in a script language. The script information specifies when and where respective component elements constituting the graphics data are to be displayed.

The data stream (TS data) configuring the broadcast program data received by the digital TV tuner 125 is transferred to the main memory 105 via the PCI bus, the south bridge 109, and the north bridge 103. The CPU 101 reads the TS data from the main memory 105, and performs various data processes on the TS data.

That is to say, the CPU 101 at first performs a process of separating the TS data into the compression-coded moving image data, the compression-coded audio data, and the compression-coded graphics data.

Next, the CPU 101 performs a process so as to transfer the separated and compression-coded moving image data to the graphics controller 107 with a predetermined frame rate (for example, 30 fps).

Here, the compression-coded moving image data is transferred from the main memory 105 to the VRAM 107a via the north bridge 103, the PCI EXPRESS bus, and the graphics controller 107. The graphics controller 107 decodes the moving image data transferred from the main memory 105, and writes the decoded moving image data to the VRAM 107a.

The CPU 101 decodes the separated graphics data, and performs a process so as to draw a graphics image to the main memory 105 based on the decoded graphics data.

The graphics image drawn to the main memory 105 is transferred to the VRAM 107a via the north bridge 103, the PCI EXPRESS bus, and the graphics controller 107 under the control of the CPU 101.

The graphics controller 107 generates a display signal by combining the decoded moving image data and graphics image data stored in the VRAM 107a by each frame, and output the generated display signal to the LCD 7.

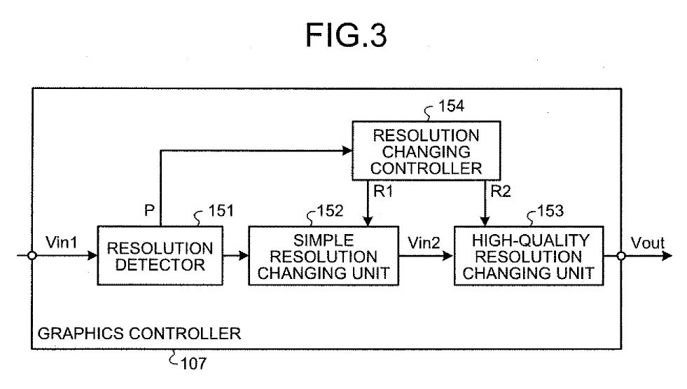

A configuration corresponding to a resolution changing process within the graphics controller 107 is shown in FIG. 3. The graphics controller 107 has a resolution detector 151, a simple resolution changing unit 152, a high-quality resolution changing unit 153, and a resolution changing controller 154.

The resolution detector 151 detects a resolution of an input moving image data Vin1 input to the graphics controller 107, and outputs a resolution data P indicating the detection result to the resolution changing controller 154. Further, the resolution detector 151 outputs the input moving image data Vin1 to the simple resolution changing unit 152.

The simple resolution changing unit 152 is a first resolution changing unit, and changes a resolution of the input moving image data Vin1 (namely, total number of pixels within one frame of the input moving image data Vin1) into a resolution higher than the detected resolution of the input moving image data Vin1 by performing an interpolation on pixels with respect to the input moving image data Vin1. Then, the simple resolution changing unit 152 outputs the changed resolution. The changing of the resolution into the resolution higher than the detected resolution of the input moving image data Vin1 is also referred to as an image size expansion.

The resolution change by the simple resolution changing unit 152 is performed without taking into account characteristics of the input moving image data Vin1, and for example, the resolution change is performed by interpolating an average pixel of adjacent pixels. Since the simple resolution changing unit 152 does not take into account the characteristics of the input moving image data Vin1, an expansion ratio showing a ratio between the resolution of the input moving image data Vin1 and a resolution of an output moving image data Vin2 can arbitrary be specified. Further, the resolution change does not require an excessive process load.

However, image quality of the image displayed by using the moving image data after expansion may not be good because the characteristics of the input moving image data Vin1 is not taken into account. Moreover, the simple resolution changing unit 152 changes the resolution in accordance with an instruction data R1 output from the resolution changing controller 154, and outputs the input moving image data Vin1 as an input moving image data Vin2 without changing the resolution thereof, when the instruction data R1 is not output from the resolution changing controller 154.

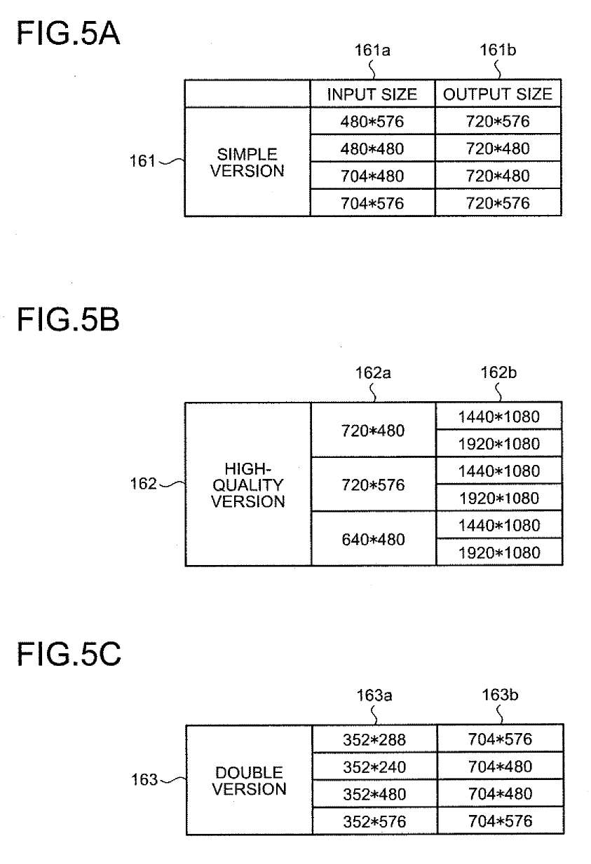

In the present embodiment, a resolution table 161 is provided for the simple resolution changing unit 152. The resolution table 161 resisters the resolution of the input moving image data Vin1 (resolution before change) and a resolution after change in relation to each other. The resolution table 161 has an input resolution storage 161a and an output resolution storage 161b, as shown in FIG. 5A. For example, a resolution of 720 pixels wide and 480 pixels long is related to a resolution of 704 pixels wide and 480 pixels long, in the resolution table 161.

The simple resolution changing unit 152 can change the resolution which is not registered in the resolution table 161 into high resolution. However, the simple resolution changing unit 152 changes the resolution in accordance with the resolution table 161 when the resolution of the input moving image data Vin1 coincides with the resolution before change stored in the input resolution storage 161a. The resolution table 161 is provided so as to make a resolution changed by the simple resolution changing unit 152 to be clear.

The high-quality resolution changing unit 153 is a second resolution changing unit, and the high-quality resolution changing unit 153 is activated when the resolution of the input moving image data Vin2 from the simple resolution changing unit 152 is a predetermined resolution. The high-quality resolution changing unit 153 outputs an output moving image data Vout after changing the resolution of the input moving image data Vin2 into a predetermined output resolution.

The high-quality resolution changing unit 153 changes the resolution while taking into account the characteristics of the input moving image data Vin2. For example, a contour portion and an edge portion of an image are distinguished from other portions, pixels are interpolated while making the best use of the contour portion and the edge portion, and the resolution is changed so as to obtain a definition higher than a definition obtained by the simple resolution changing unit 152. Further, the high-quality resolution changing unit 153 changes the resolution while taking into account the characteristics of the input moving image data Vin2, so that the expansion ratio is limited only to a certain predetermined ratio. Accordingly, it becomes possible to change the resolution without an excessive process load.

The changing of the resolution is performed based on the characteristics of the input moving image data Vin2, so that the image quality of the image displayed by using the image data after expansion becomes an extremely good such that the contour portion and the edge portion thereof are shown clearly, even though the process load is required. Moreover, the high-quality resolution changing unit 153 changes the resolution in accordance with an instruction data R2 output from the resolution changing controller 154, and outputs the output moving image data Vout.

In the present embodiment, a resolution table 162 is provided for the high-quality resolution changing unit 153. The high-quality resolution changing unit 153 changes the resolution when the resolution of the input moving image data Vin2 is registered in the resolution table 162, and does not change the resolution when the resolution is not registered in the resolution table 162.

The resolution table 162 registers input prescribed resolutions and output prescribed resolutions in relation to each other, and has an input resolution storage 162a and an output resolution storage 162b as shown in FIG. 5B. For example, a resolution of 720 pixels wide and 480 pixels long is related to a resolution of 1920 pixels wide and 1080 pixels long in the resolution table 162.

It can be seen by comparing the resolution table 161 and the resolution table 162 that all of the resolutions registered in the output resolution storage 161b of the resolution table 161 coincide with the input prescribed resolutions registered in the input resolution storage 162a of the resolution table 162. Hence, the resolution can be changed at the high-quality resolution changing unit 153 by changing the resolution at the simple resolution changing unit 152 in advance even if the resolution of the input moving image data Vin1 cannot be changed at the high-quality resolution changing unit 153.

The resolution changing controller 154 determines activation patterns of the simple resolution changing unit 152 and the high-quality resolution changing unit 153 in accordance with the resolution data P, and activates the simple resolution changing unit 152 or the high-quality resolution changing unit 153 in accordance with the activation pattern. An operation thereof will be described later in detail. The activation patterns indicate that each of the simple resolution changing unit 152 and the high-quality resolution changing unit 153 is to be activated with which expansion ratio.

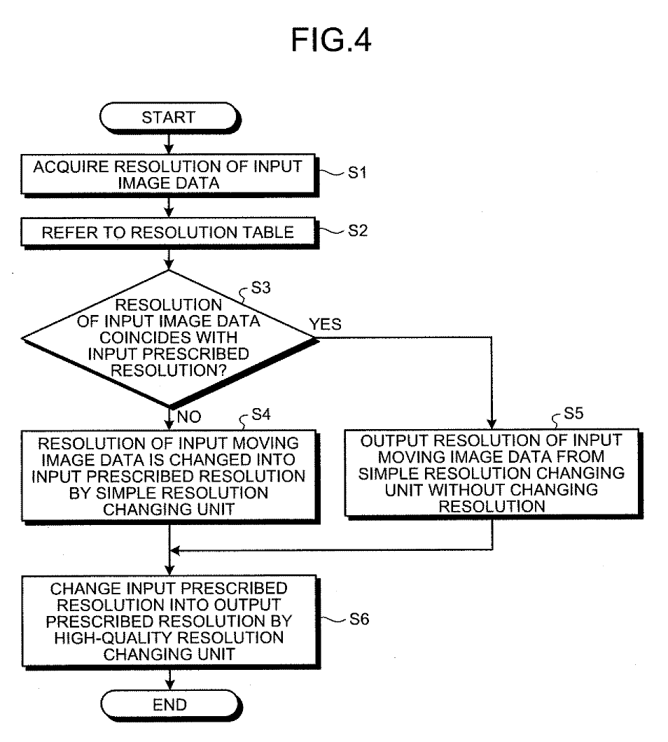

Next, an operation of the resolution changing process in the graphics controller 107 is described with reference to a flowchart shown in FIG. 4. FIG. 4 is a flowchart of an operational procedure of the resolution changing process. The resolution changing process is performed in accordance with the control of the resolution changing controller 154

The resolution changing controller 154 starts the resolution changing process, and acquires the resolution of the input moving image data Vin1 from the resolution data P output from the resolution detector 151 (S1). Next, the resolution changing controller 154 advances the operation to S2, and refers to the resolution table 162. Subsequently, the resolution changing controller 154 advances the operation to S3, and determines whether the resolution of the input moving image data Vin1 coincides with the input prescribed resolution registered in the input resolution storage 162a of the resolution table 162 (S3). Here, the resolution changing controller 154 advances the operation to S4 when they do not coincide with each other, and advances the operation to S5 when they coincide with each other.

The resolution changing controller 154 advances the operation to S4, and refers to the input resolution storage 161a of the resolution table 161 by using the resolution of the input moving image data Vin1. The resolution changing controller 154 acquires from the output resolution storage 161b the resolution corresponding to the input resolution storage 161a that coincides with the resolution of the input moving image data Vin1, outputs the instruction data R1, and let the simple resolution changing unit 152 perform the interpolation and the like on the pixels so that the resolution of the input moving image data Vin1 becomes the acquired resolution.

The resolution changing controller 154 advances the operation to S5, and outputs the resolution from the simple resolution changing unit 152 without changing the resolution of the input moving image data Vin1 (the expansion ratio is set to be “1”).

Then, the resolution changing controller 154 advances the operation to S6 after S4 or S5, and refers to the input resolution storage 162a of the resolution table 162 by using the resolution of the input moving image data Vin2. The resolution changing controller 154 acquires from the output resolution storage 162b the resolution corresponding to the input resolution storage 162a that coincides with the resolution of the input moving image data Vin1, outputs the instruction data R2, and let the high-quality resolution changing unit 153 perform the interpolation and the like on the pixels by taking into account the characteristics of the image so that the resolution of the input moving image data Vin2 becomes the acquired resolution. The resolution changing controller 154 finishes the resolution changing process after S6.

In the following, it is described as a example a case when the resolution of the input moving image data Vin1 of 704 pixels wide and 480 pixels long (704×480) is changed to the resolution of a full HD (referred also as to a full high vision), that is the resolution of 1920 pixels wide and 1080 pixels long (1920×1080).

In general, a resolution of a moving image data obtained by receiving a broadcast in SD (standard definition) is 720 pixels wide and 480 pixels long (720×480), and on the other hand, the resolution of 704×480 is used in a digital video camera and the like.

Accordingly, it is assumed that the input moving image data Vin1 with the resolution of 704×480 generated by the digital video camera and the like is input to the graphics controller 107.

When an image size of the input moving image data Vin1 is expanded by activating only the high-quality resolution changing unit 153 and not by activating the simple resolution changing unit 152, the expansion ratio in a lateral direction at the high-quality resolution changing unit 153 becomes 1920/704=30/11 (referred to as a changing example 1).

On the other hand, when the resolution of the input moving image data Vin1 is once changed into the input prescribed resolution by activating the simple resolution changing unit 152, and thereafter, the image size is expanded by activating the high-quality resolution changing unit 153, the expansion ratio at the high-quality resolution changing unit 153 becomes 1920/720=8/3 (referred to as a changing example 2).

In the changing example 2, the interpolation on pixels is performed so as to generate 8 pixels from 3 pixels, and on the other hand, in the changing example 1, the interpolation on pixels is performed so as to generate 30 pixels from 11 pixels. In the changing example 1, the numerals are larger than that in the changing example 2 for before the changing and after the changing.

Hence, when the pixels are interpolated, a calculation process has to be performed by, for example, securing a large size of table storing a relation between respective pixels of the input moving image data and pixels of the output moving image data. Accordingly, a memory has to be secured largely.

Consequently, the excessive process load is required for changing the resolution, so that the high-quality change is difficult to realize. Further, the resolution cannot be changed if the process load is tried to be suppressed.

Furthermore, the process making the best use of the characteristics of the image such as the interpolation on pixels considering the edge is difficult to perform because the excessive process load is required.

When the resolution is changed by regarding 704 pixels wide as 720 pixels wide, 16 pixels correspond to 43 pixels in the input moving image data after expansion. As a result, black band state portions are displayed at both sides when the image is displayed by using the above-stated resolution. Accordingly, it becomes impossible to respond to a requirement to flexibly change the image size even though the image quality after change is high.

Further, when the resolution is changed by both of the simple resolution changing unit 152 and the high-quality resolution changing unit 153, the activation patterns of the simple resolution changing unit 152 and the high-quality resolution changing unit 153 are determined in advance. As a result, although the resolution can be changed without the excessive process load, the resolution cannot be changed without causing the excessive process load when the input moving image data with the resolution requiring the changing of the activation pattern is input.

On the other hand, in the graphics controller 107, the resolution of the input moving image data Vin1 is detected by the resolution detector 151, determines the activation pattern in accordance with the resolution, and activates the simple resolution changing unit 152 or the high-quality resolution changing unit 153 in accordance with the activation pattern.

In particular, the resolution changing controller 154 refers to the resolution table 162, determines whether the resolution of the input moving image data Vin1 coincides with the input prescribed resolution which can be used by the high-quality resolution changing unit 153. When they do not coincide with each other, the resolution changing controller 154 activates the simple resolution changing unit 152 to change the resolution into the input prescribed resolution in advance, and thereafter, activates the high-quality resolution changing unit 153.

Accordingly, the input prescribed resolution can be changed into the output prescribed resolution by the high-quality resolution changing unit 153, and therefore, it becomes possible to fully make the best use of the resolution change function of the high-quality resolution changing unit 153. In addition, the resolution can be changed without requiring the excessive process load of the high-quality resolution changing unit 153. Here, although the simple resolution changing unit 152 is activated, the simple resolution changing unit 152 changes the resolution without considering the characteristics of the input moving image data Vin1. Therefore, it becomes possible to change the resolution without requiring the excessive process load.

When the resolution of the input moving image data Vin1 coincides with the input prescribed resolution, it is unnecessary to activate the simple resolution changing unit 152. Hence, the resolution changing controller 154 outputs an instruction data R to make the expansion ratio of the simple resolution changing unit 152 to be “1”.

Further, the resolution of the input moving image data Vin1 is detected by the resolution detecting portion 151, and the simple resolution changing unit 152 and the high-quality resolution changing unit 153 are activated with the activation patterns in accordance with the detection results. Accordingly, it becomes possible to change the resolution in an optimum state without unnecessary increasing the process load, even if the input moving image data with any resolution is input thereto.

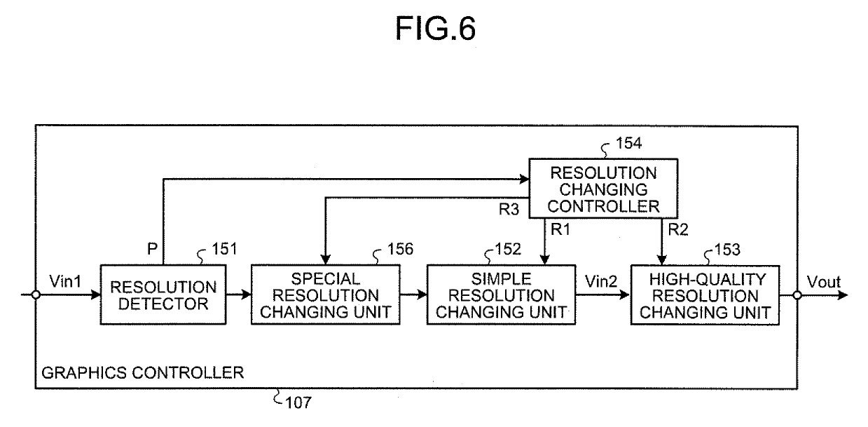

In addition to the above-stated embodiments, a resolution table 163 shown in FIG. 5C may be provided, and a special resolution changing unit 156 may be provided between the resolution detector 151 and the simple resolution changing unit 152 in the graphics controller 107, as shown in FIG. 6.

The special resolution changing unit 156 is provided to expand the resolution of the input moving image data Vin1 double as for a special case when the resolution of the input moving image data Vin1 is small. The special resolution changing unit 156 expands the resolution double by performing the interpolation and the like on the pixels, and outputs an input moving image data Vin3 to the simple resolution changing unit 152.

The resolution table 163 is provided for the special resolution changing unit 156. Here, all of the resolutions in an output resolution storage 163b coincide with the input resolution storage 161a. Accordingly, it becomes possible to change the resolution of the input moving image data Vin1 with the determined expansion ratio by the simple resolution changing unit 152 and to reduce the process load, if the resolution is changed by the special resolution changing unit 156 before the resolution is changed by the simple resolution changing unit 152 in the special case when the resolution of the input moving image data Vin1 is small.

The resolution changing controller 154 outputs an instruction data R3 by the resolution data P in a special case when the resolution of the input moving image data Vin1 is small, and activates the special resolution changing unit 156. The special resolution changing unit 156 does not change the resolution and leaves it as it is when the instruction data R3 is not outputted, and outputs the input moving image data Vin1.

The above description is for explaining the embodiments of the invention and does not limit the apparatus and the method of the invention, and various modification examples thereof can be implemented easily. Further, an apparatus or a method formed by appropriately combining the components, functions, features or method steps in each embodiment is also included in the invention.

The computer 1 is assumed to be, for example, a portable note-type computer as an example in the present embodiment, but the present invention is not limited to the note-type computer. Besides, in the present embodiment, it is described for the computer as an example, but it can also be applied to a TV apparatus, and a data recording apparatus recording data to a recording medium by a DVD and so on.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processor, comprising:
a resolution detector that detects a resolution of an input image data;
a first resolution changing unit that changes the detected resolution into a resolution that is higher than the detected resolution;
a second resolution changing unit that changes the detected resolution coinciding with a predetermined input resolution into a predetermined output resolution that is higher than the detected resolution so as to provide the input image data with a definition higher than a definition of an output image data provided with the resolution changed by the first resolution changing unit; and
a resolution changing controller that activates the first resolution changing unit to change the detected resolution that does not coincide with the predetermined input resolution into the predetermined input resolution, and activates subsequently the second resolution changing unit.

2. The image processor according to claim 1, further comprising:
a resolution storage that stores the predetermined input resolution and the predetermined output resolution in relation to each other; and
a determination unit that determines whether the detected resolution coincides with the predetermined input resolution with reference to the resolution storage, wherein
the resolution changing controller activates the second resolution changing unit based on a determination result of the determination unit.

3. The image processor according to claim 1, further comprising:
a resolution storage that stores a resolution before change and a resolution after change used by the first resolution changing unit, the resolution before change and the resolution after change being stored in relation to each other, wherein
the first resolution changing unit changes the detected resolution into the resolution after change that corresponds to the resolution before change coinciding with the detected resolution.

4. The image processor according to claim 1, wherein
the resolution changing controller activates the second resolution changing unit without changing by the first resolution changing unit the detected resolution that coincides with the predetermined input resolution.

5. The image processor according to claim 1, wherein
a resolution of 720 pixels wide and 480 pixels long is set as the predetermined input resolution and a resolution of 1920 pixels wide and 1080 pixels long is set as the predetermined output resolution corresponding to the predetermined input resolution in the second resolution changing unit.

6. The image processor according to claim 1, wherein
the first resolution changing unit changes the detected resolution of 704 pixels wide and 480 pixels long into the resolution of 720 pixels wide and 480 pixels long.

7. An image processing method, comprising:
detecting a resolution of an input image data;
changing the detected resolution not coinciding with a predetermined input resolution into the predetermined input resolution that is higher than the detected resolution; and
changing the detected resolution that coincides with the predetermined input resolution into a predetermined output resolution that is higher than the detected resolution so as to provide the input image data with a definition higher than a definition of an output image data provided with the predetermined input resolution.
